(19) United States
(12) Patent Application Publication
(10) Pub. No.: US 2004/0256780 A1
(43) Pub. Date: Dec. 23, 2004

(54) Jig, which can be precisely repositioned

(76) Inventor: Gunter Lang, Wernau (DE)

Correspondence Address: FITCH, EVEN, TABIN & FLANNERY, P. O. BOX 65973, WASHINGTON, DC, 20035, US

(21) Appl. No.: 10/495,076

(22) PCT Filed: Nov. 7, 2002
(86) PCT No.: PCT/DE02/04133

(30) Foreign Application Priority Data
Nov. 9, 2001 (DE) 101 55 077.4

(51) Int. Cl. B23Q 3/00

(52) U.S. Cl. 269/309

(57) ABSTRACT

For an accurate clamping of a workpiece chuck (2), a clamping device (1) has a reference-plane plate (4) and a clamping plate (3) which are brought into a face-to-face contact with one another. In another reference-plane plate (4) clamping openings (8, 9, 10, 11) are formed with which clamping and positioning pins (21, 22, 23, 24) are associated. The latter are held on the clamping plate (3). The clamping and positioning pins (21, 22, 23, 24) utilize a portion of the wall (12, 13, 14, 15) of the clamping openings (8, 9, 19, 11) as reference surfaces, when they are resiliently pressed thereagainst. For this purpose a tightening device (40) is provided which not only clamps the clamping and positioning pins (21, 22, 23, 24) axially, but also presses them against the bore wall in a different radial direction.

The invention relates to a clamping device having an increased repetitive clamping accuracy.

It is a frequent requirement in practice to clamp a workpiece holder with repetitive accuracy. For such a purpose it is necessary to be able to accurately position the workpiece holder according to six degrees of freedom, that is, according to three linear coordinates X, Y, Z and three rotary directions (rotary about the X axis, the Y axis and the Z axis). If the workpiece is to be clamped for the purpose of workpiece machining, often substantial forces imparted to the workpiece have to be taken into consideration; that is, such forces have to be taken up by the clamping device without causing a dislocation of the workpiece. Therefore, the clamping devices have to be of robust construction. A force transmission between the individual elements must not occur in a point-like concentrated manner, since that would lead to excessive loads on the materials of the clamping device and thus would result in deformations.

It is therefore an object of the invention to provide a clamping device which is adapted for use in chip-breaking machining of clamped workpieces and which makes possible a high degree of repetitive clamping accuracy.

The above object is achieved by the clamping device according to the invention. The clamping device includes a reference-plane plate having a planar clamping surface in which clamping openings are provided. The clamping openings have walls which, at least in sections, define reference surfaces oriented essentially perpendicularly to the reference plane of the reference-plane plate. The clamping surface of the reference-plane plate constitutes a reference plane. The clamping plate is pressed by a tightening device against the clamping surface and is highly accurately held as concerns the direction perpendicular to the clamping surface. The reference surfaces provided in the clamping openings ensure a repetitive clamping accuracy as concerns the directions lying in the reference plane. The reference surfaces are machined with such an accuracy that they may serve for the positioning of the workpiece clamping device with the desired accuracy. Positioning surfaces provided on clamping and positioning pins are associated with the reference surfaces. The clamping and positioning pins thus assume the task of an accurate alignment of the clamping plate with the directions lying in the reference plane. This is achieved by imparting, by the tightening device, to the clamping and positioning pins not only an axial force, but also a superposed radial force which spreads the clamping and positioning pins away from one another (or bends them toward one another) and presses their respective positioning surfaces against the positioning surface. By spreading apart (or bending to one another) the clamping and positioning pins, which may effect an elastic deformation thereof in the one-hundredth or one-tenth mm range, in the course of each clamping step the position of the clamping plate orients itself repeatedly in such a manner that a force equilibrium is obtained between the clamping and positioning pins which underwent a flexible excursion. Based on the own substantial rigidity of the clamping and positioning pins, such a force equilibrium is set with respect to the clamping plate with an accuracy which lies in the micron range. By virtue of the clamping and positioning pins lying against the reference surfaces, an accurate and repetition-secure positioning of the clamping plate is obtained.

In principle, the clamping surface as well as the base surface may be formed by a plurality of coplanar surface regions. Such a solution is especially expedient if only small clamping forces are to be transmitted. Particularly large forces may be transmitted, however, if the clamping surface and the base surface are each throughgoing and coherent. A moderate surface pressure is obtained which makes possible the transmission of large forces. Further, a larger static friction is obtained between the participating surfaces which also makes possible the transmission of large forces in a direction parallel to the clamping surface and the base surface.

The positioning pins preferably have such a size and position that they project into the clamping openings in the relaxed state without lying on the reference surfaces with their positioning surfaces. They are thereafter spread out (or pressed together) by the tightening device, whereby the respective positioning and reference surfaces brought into contact with one another. This is particularly advantageous when the clamping pins and the clamping openings are in a coaxial alignment, or at least have mutually parallel central axes or length directions. According to an equally feasible alternative embodiment the clamping openings and the clamping pins are not in a completely parallel alignment, but are oriented at a small acute angle to one another. For example, the clamping pins are aligned parallel to one another, while two associated clamping openings are oriented obliquely in different directions or are, in the alternative, laterally offset and slightly conical. Upon drawing the clamping pins into the clamping openings, the clamping pins arrive into contact with the walls of the clamping openings, whereby the clamping pins obtain the desired radial force component. As a result, they are either spread apart, or moved toward one another. Either event leads to the desired clamping of repetitive accuracy.

According to a preferred embodiment the clamping openings and the clamping pins are oriented parallel to one another, and the clamping and positioning pins are of smaller size than he clamping openings. Such an arrangement is advantageous in that they may be introduced into the clamping openings without being exposed to forces which facilitates the clamping process.

The clamping and positioning pins are advantageously slightly resilient in their radial direction. In the alternative, a certain resilient yield of the respective reference surface may be provided. Both measures may be used for centering the clamping plate.

The maximum spring stroke of the clamping and positioning pins is preferably greater than the distance of the positioning surfaces of the positioning pins from the reference surfaces. This feature ensures that the clamping and positioning pins are not damaged during the clamping process.

The positioning surfaces of the clamping and positioning pins are preferably cylindrically curved which is not only advantageous as concerns finishing work, but also offers the possibility of an accurate positioning.

The positioning pins have preferably a cylindrical base shape and are provided with a wedge-shaped or a dual-conical clamping aperture. The wedge-shaped clamping aperture is advantageous in that a clamping wedge entering into engagement finds a good surface seating, whereby large clamping forces may be obtained. It is, in turn, an advantage of the dual-conical clamping aperture that the clamping pin needs no particular angular alignment. It may be, for example, a screw-in pin screwed into threaded bores provided in the clamping plate. Further, by virtue of the dual-conical recess of the clamping aperture a greater flexibility for the clamping pin may be obtained.

The clamping device has at least two, but preferably three or four clamping pins and clamping openings. The arrangement with three clamping pins which are spread radially away from, or bent radially toward, one another, may find application, for example, in rotary chucks where the clamping plate is to be fastened to a rotary machine element. The arrangement having four, or even more clamping pins is particularly adapted for clamping rectangular clamping plates, for example, in case of stationarily supporting the workpiece.

The clamping device has several clamping plungers. Preferably, to each clamping pin a respective clamping plunger is associated which imparts an axial and a radial force to the clamping pin. The clamping plungers are driven in synchronism with one another to cause a simultaneous, flexible excursion of the clamping pins. Such an arrangement has the significant advantage that a centering of the clamping plate is effected with good accuracy at the very beginning of the clamping process, so that microscopically small slipping motions between the clamping plate and the reference-plane plate do not occur after the clamping pins have been exposed to an axial force.

A wedge drive or a hydraulic drive may be utilized for driving the clamping plungers. Both are preferably driven from a single driving source.

With the clamping pins a pre-centering device may be associated which positions the clamping pins at the beginning of the clamping process approximately centrally in the respective clamping opening. This feature may contribute to a reduction of the load on the clamping and positioning pins.

According to an advantageous embodiment at least with one clamping pin, but preferably with each clamping pin, a press-down device is associated which biases the clamping and positioning pins with an axial force directed outward of the clamping opening. This feature supports the lifting of the clamping plate from the reference-plane plate after loosening the tightening device.

Further advantageous details of embodiments according to the invention may be obtained from the drawing, the description pertaining thereto or from the dependent claims.

Several embodiments are illustrated in the drawing, where

FIG. 1 is a schematic, fragmentary, sectional side elevational view of a clamping device for clamping a workpiece and having a reference-plane plate as well as a clamping plate separated therefrom;

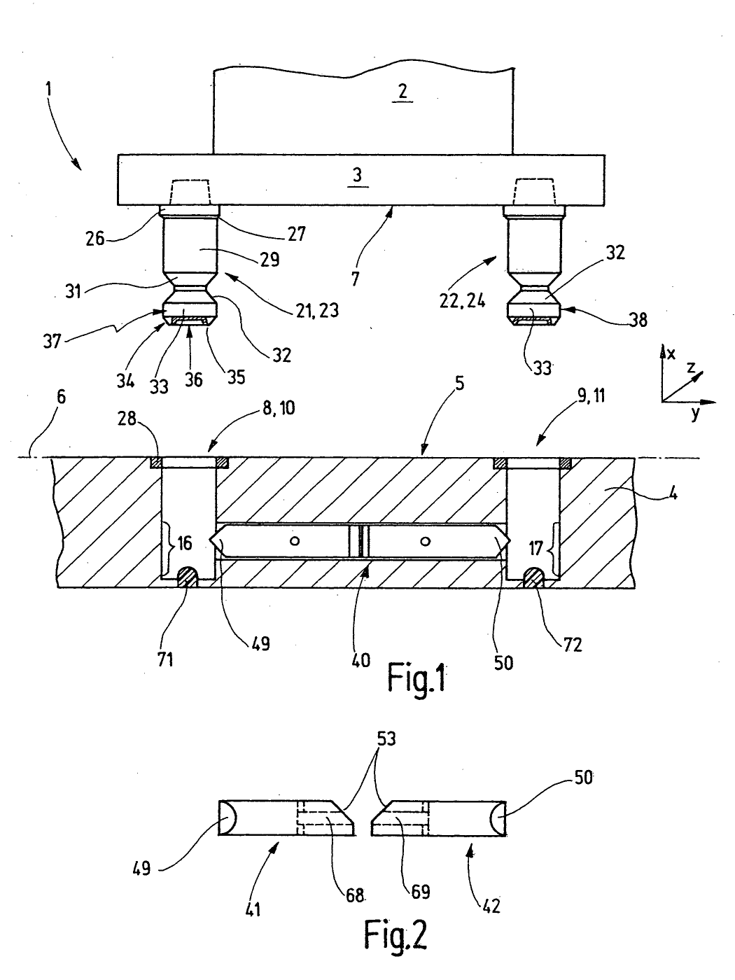

FIG. 2 is a top plan view of two clamping wedges of the clamping plate of FIG. 1,

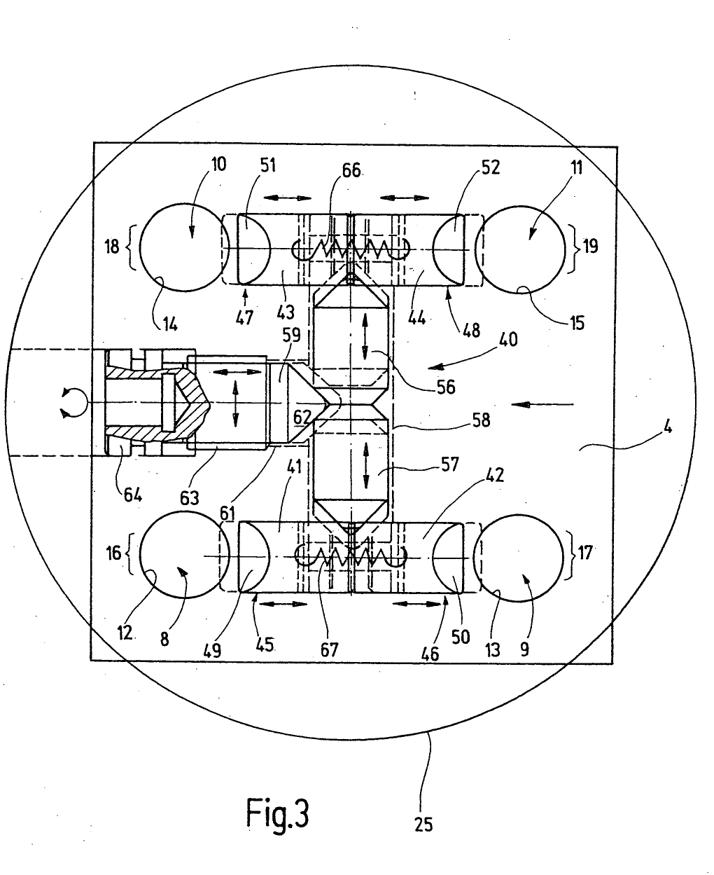

FIG. 3 is a schematic top plan view of the clamping device of FIG. 1,

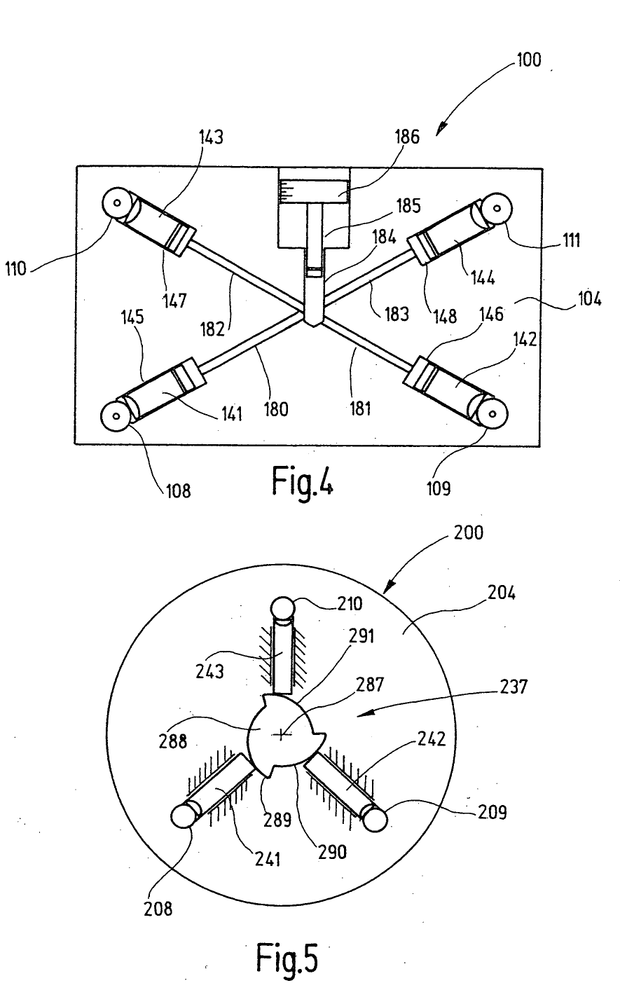

FIG. 4 is a schematic top plan view of a modified embodiment of the clamping device and

FIG. 5 is a schematic top plan view of a further modified embodiment of the clamping device.

FIG. 1 illustrates a clamping device 1 for clamping an only symbolically shown workpiece chuck 2 in an accurate position. For this purpose, the workpiece chuck 2 is affixed to a clamping plate 3 or constitutes a part thereof. The clamping plate 3 is to be clamped against a reference-plane plate 4 which is held, for example, stationarily or on an accurately movable table or on another machine element displaceable in a controlled manner. The reference-plane plate has on its upper side a planar clamping surface 5 which defines a reference plane 6. The clamping surface 5 lies entirely in the reference plane 6 and is preferably a coherent surface. In the alternative, and if required, non-illustrated apertures may be provided in the clamping surface 5.

The clamping plate 3 has, on its side facing the clamping surface 5, a base surface 7 which is to be brought into a face-to-face contact with the clamping surface 5 upon tightening the clamping plate 3 against the reference-plane plate 4. The reference-plane plate 4 thus defines, with its clamping surface 5, the position of the workpiece chuck 2 in the X direction.

For positioning in the Y and Z directions, in the reference-plane plate 4 clamping openings 8, 9, 10, 11 (see also FIG. 3) are provided which may be, for example, cylinder bores. Each has a respective cylindrical wall 12, 13, 14, 15, of which at least one portion constitutes a reference surface 16, 17, 18, 19. The reference surfaces 16, 17, 18, 19 are thus cylindrically curved and formed by a part of the respective walls 12, 13, 14, 15. The reference surfaces 16, 17, 18, 19 serve for positioning clamping and positioning pins 21, 22, 23, 24 which are held on the clamping plate 3. The clamping and positioning pins 21, 22, 23, 24 are, for example, screw-in pins and are screwed into respective threaded bores provided in the underside of the clamping plate 3. The clamping and positioning pins 21, 22, 23, 24 thus project perpendicularly away from the base surface 7 and are oriented parallel to one another. The clamping and positioning pins 21, 22, 23, 24 are preferably arranged in a rectangle, coaxially with the clamping openings 8, 9, 10, 11 shown in FIG. 3. The clamping openings 8, 9, 10, 11 are arranged preferably in the vicinity of the corners of the reference-plane plate 4 which may be, for example, of square shape. The reference-plane plate 4, however, may also be a circular plate, as shown in FIG. 3 by a line 25, or may have a different outline.

The clamping and positioning pins 21, 22, 23, 24 are of identical structure. The description of the clamping pin 21 that follows thus applies equally to the others. Immediately adjoining the base surface 7, the clamping pin 21 is provided with a centering collar 26 which has a cylindrical outer periphery and an adjoining conical portion 27. It serves for a pre-centering of the clamping and positioning pin in the clamping opening 8, whose edge is formed by a centering ring 28 leading funnel-shaped into the opening. Adjoining the conical portion, the clamping and positioning pin 21 continues in a cylindrical part which has a lesser diameter than that of the centering collar 26. The diameter of the cylindrical part 29 is by a few tenths or hundredths mm less than the diameter of the clamping opening 8, so that the clamping and positioning pin 21 assumes its position in the clamping opening 8 with a play. Adjoining the cylindrical portion 29, the clamping and positioning pin 21 first tapers into a cone portion 31 which continues in another cone portion 32. The cone portion 32 is oriented inversely with respect to the cone portion 31 and thus enlarges the diameter of the positioning pin 21 back to its original diameter. Thus, the cone portion 32 is joined by a cylindrical portion 33 whose diameter approximately equals the diameter of the cylindrical portion 29. At its lower end a lead-in chamfer 34 is adjoined by a flat end face 35 that may be provided with a frontal aperture 36.

The clamping and positioning pin has a slightly flexible structure or support, so that upon applying thereto a force in the Y direction or Z direction (radial force), it is flexibly displaced. It has a high degree of spring hardness, and its maximum spring stroke is at least as large as the difference between the radius of the cylindrical portion 33 and the radius of the reference surface 16. The cylindrical portions 33 of the individual clamping and positioning pins 21, 22 (23, 24) thus form, at least with their locations facing the reference surfaces 16, 17, positioning surfaces 37, 38 which are associated with the reference surfaces 16, 17.

For clamping the clamping plate 3, a tightening device 40 is provided which serves for applying a force, lying in the X-Z plane, to each of the clamping and positioning pins 21, 22, 23, 24 in the axial direction X (downward in FIG. 1), as well as in a selected radial direction. In the illustrated embodiment the tightening device 40 includes clamping plungers 41, 42, 43, 44, a separate one being associated with each clamping and positioning pin. The clamping plungers 41, 42, 43, 44 are shiftably supported in bores 45, 46, 47, 48 which extend transversely to the clamping openings 8, 9, 10, 11. By virtue of this arrangement the clamping plungers 41, 42, 43, 44 are each movable away from, or toward, the respective clamping and positioning pins 21, 22, 23, 24. In the embodiment, as shown in FIG. 3, the clamping plungers 41, 42, 43, 44 are of identical length. They may, however, have different lengths, that is, the clamping plungers 41, 43 may be longer or shorter than the clamping plungers 42, 44. Accordingly, the clamping system may be displaced from the center without adversely affecting the operation. The center of the reference-plane plate 4 may therefore be maintained free, so that openings and passages may be provided at that location. The bores 45, 46, 47, 48 open laterally into the clamping openings 8, 9, 10, 11, so that the clamping plungers 41, 42, 43, 44 may penetrate into the clamping openings 8, 9, 10, 11 and may be withdrawn therefrom, as indicated in broken lines in FIG. 3. The clamping plungers, which may have a circular cross section, have wedge-shaped heads 49, 50, 51, 52, whose side view is shown in FIG. 1 and which are separately shown in FIG. 2. The heads 49, 50 serve as wedges for clamping the cone portions 32 of the clamping and positioning pins 21, 22, 23, 24.

At their reverse ends, the clamping plungers 41, 42, 43, 44 are provided with a respective bevel 53 which is transverse to the plunger head and into which, as shown in FIG. 3, wedged plungers 56, 57 of identical or different length may extend. In case the wedged plungers 56, 57 are of different length, their drive may be disposed eccentrically. The wedged plungers 56, 57, when expanded, force the clamping plungers 41, 42, 43, 44 away from one another. The wedged plungers 56, 57 are disposed with a play in a connecting bore 58 which extends perpendicularly to the bores 45, 46, 47, 48. By virtue of the play, the wedged plungers 56, 57 are floatingly supported. The wedged plungers, in turn, may be forced away from one another by a driving plunger 59 which fits between the ends of the wedged plungers 56, 57 with a wedge-shaped head and which is disposed in a bore 61 extending, for example, parallel to the bores 45, 46, 47, 48. The driving plunger 59 may have, for example, a conical end 62 and may be provided with an external thread 63. Further, the driving plunger 59 is provided with a head 64 for receiving a tool in a form-fitting manner. By rotating the head 64, the driving plunger 59 may be screwed into, or out of, the bore 61.

The wedged plungers 56, 57 together with the mechanically, pneumatically, hydraulically or electrically actuated driving plunger 59 constitute a cam drive 65 which serves for actuating the clamping plungers 41, 42, 43, 44.

If required, the cam drive 65 may be provided with a resetting device, formed of at least two springs 66, 67 which are, for example, tension springs and which are disposed in respective axial bores 68, 69 of the clamping plungers 41, 42, 43, 44. The springs 66, 67 pull the clamping plungers 41, 42 and, respectively, 43, 44 toward one another into a position in which they do not project into the clamping openings 8, 9, 10, 11.

On the bottom of the clamping openings 8, 9, 10, 11 rubber buffers 71, 72 may be arranged which project into the recesses 36 provided in the end face of the clamping and positioning pins 21, 22, 23, 24. The buffers 71, 72 serve for guiding the clamping pins 21, 22, 23, 24 axially out of their clamping position. Upon such an occurrence the base surface 7 at least slightly lifts off the clamping surface 5.

The above-described clamping device 1 operates as follows:

For clamping the clamping plate 3, the latter is first guided to the reference-plane plate 4, and the clamping and positioning pins 21, 22, 23, 24 are introduced into the clamping openings 8, 9, 10, 11. When the frontal apertures 36 assume their position on the rubber buffers 71, 72, the centering edges 26 are already positioned within centering rings 28, so that the clamping and positioning pins 21, 22, 23, 24 are pre-centered. Further, the cone portions 32 are situated immediately in front of the heads 49, 50, 51, 52 of the clamping plungers 41, 42, 43, 44 that had been reset by spring effect. Upon actuation of the driving plunger 59 by screwing it into its bore 61, the wedged plungers 56, 57 are driven away from one another, and, at the same time, they assume a centered position between the ends of the clamping plungers 41, 42, 43, 44. The connecting bore 58 is significantly oversized with respect to the wedged plungers 56, 57, so that the latter sit with a play in the connecting opening 58. Thus, a centering is effected by the clamping plungers which, in turn, are centered by the clamping and positioning pins 21, 22, 23, 24. A uniform force distribution occurs to all four clamping plungers 41, 42, 43, 44 which first displace the clamping and positioning pins 21, 22, 23, 24 in the Y direction, that is, in as radial direction. During this occurrence the clamping and positioning pins 21, 22, 23, 24 lie against the reference surfaces 16, 17, 18, 19 with their positioning surfaces 37, 38. They thus are resiliently clamped outward, whereby the clamping plate 3 assumes a center position in which the spring energy stored in the clamping and positioning pins 21, 22, 23, 24 is at a minimum. Due to the high degree of spring hardness of the clamping and positioning pins 21, 22, 23, 24, such an energy minimum, and thus the center position of the clamping plate 3, is sharply defined. If the driving plunger 59 is continued to be tightened, the wedge-shaped heads 49, 50, 51, 52 press on the cone surfaces 32 further outward, whereby a clamping of the clamping and positioning pins 21, 22, 23, 24 in the downward axial direction (opposite the X direction) is achieved as well. In this manner the clamping plate 3 is firmly clamped against the reference-plane plate 4, and, at the same time, the rubber buffers 71, 72 are compressed.

If the driving plunger 59 is screwed out of its bore 61, the springs 66, 67 can again pull the clamping plungers 41, 42, and, respectively, 43, 44 toward one another, whereby the clamping and positioning pins 21, 22, 23, 24 are freed. The rubber buffers 71, 72 may relax and press the clamping and positioning pins 21, 22, 23, 24 at least slightly in the axial direction (direction X) from the clamping openings 8, 9, 10, 11.

FIG. 4 illustrates in a schematic top plan view a different clamping device 100, including a clamping plate 103 and a reference-plane plate 104. Associated with the clamping openings 108, 109, 110, 111 of the reference-plane plate 104 are clamping plungers 141, 142, 143, 144 which lie in a diagonal direction of the rectangle defined by the clamping openings 108, 109, 110, 111. Further, the clamping plungers are held displaceably and in a sealed manner in bores 145, 146, 147, 148 in which they close off fluid chambers for a hydraulic fluid. The fluid chambers are in communication by means of conduits 180, 181, 182, 183 with a hydraulic chamber 184 in which a driving piston 185 is displaceably supported in sealed manner. The driving piston is purposefully shiftable by a threaded drive 186. The hydraulic system (hydraulic drive 187) formed of the hydraulic chamber 184, the conduits 180, 181, 182, 183 and the clamping plungers 141, 142, 143, 144 is hermetically sealed outward and is entirely filled with hydraulic fluid. A shift of the hydraulic piston 185 results in a corresponding shift of the clamping plungers 141, 142, 143, 144, while a uniform force distribution occurs.

A further clamping device 200, adapted for a rotary support of a workpiece chuck 200, including a clamping plate 203 and a reference-plane plate 204 is illustrated in FIG. 5. A total of three clamping openings 208, 209, 210 are provided which are arranged at 1200 to one another relative to a rotary axis 287. The clamping plungers 241, 242, 243 which are radially expandable relative to the rotary axis 287 are slidably supported in respective radial bores. For actuation a central cam 288 is provided which is supported for rotation about the rotary axis 287. The central cam has at its outer periphery clamping surfaces 289, 290, 291 which are associated with respective clamping plungers 241, 242, 243 and whose radius increases in the radial direction. Turning of the cam 288 against the base body forming the reference-plane plate 204 and thus against the clamping plungers 241, 242, 243 expands the latter, until their heads enter into the clamping openings 208, 209, 210 and firmly clamp the respective clamping and positioning pins.

Respective clamping plates provided with clamping pins are associated with the reference-plane plate 104 according to FIG. 4 as well as the reference-plane plate 204 according to FIG. 5 as it was described in conjunction with FIG. 1 to 3; in each instance the clamping pins are disposed coaxially with the clamping openings 108, 109, 110, 111 and, respectively, 208, 209, 210. Further they to assume the resilient centering of the clamping plate. When the clamping plate is clamped firmly against the reference-plane plate, the once-set centering is defined irrevocably by adhering friction between the base surface 7 and the clamping surface 5.

For an accurate clamping of a workpiece chuck 2, a clamping device 1 has a reference-plane plate 4 and a clamping plate 3 which are brought into a face-to-face contact with one another. In the reference-plane plate 4 clamping openings 8, 9, 10, 11 are formed with which clamping and positioning pins 21, 22, 23, 24 are associated. The latter are held on the clamping plate 3. The clamping and positioning pins 21, 22, 23, 24 utilize a portion of the wall 12, 13, 14, 15 of the clamping openings 8, 9, 10, 11 as reference surfaces, when they are resiliently pressed thereagainst. For this purpose a tightening device 40 is provided which not only clamps the clamping and positioning pins 21, 22, 23, 24 axially, but also presses them against the bore wall in a different radial direction.

1. A clamping device (1), particularly for clamping workpieces to be submitted to a chip breaking operation, comprising
a reference-plane plate (4) defining a planar clamping surface (5) that defines a reference plane, and has at least two clamping openings (8, 9) including walls (12, 13) with at least one reference plane (16, 17) formed on each wall,
a clamping plate (3) having a planar base surface (7) to be positioned on the clamping surface (5) and at least two clamping and positioning pins (21, 22) which are associated with the clamping openings (8, 9) and each of which has a positioning surface (37, 38) which are associated with the reference surfaces (16, 17), and
a tightening device (40) arranged for applying an axial force and a superposed radial force to the clamping and positioning pins (21, 22), in order to press, with the axial force, the base surface (7) against the clamping surface (5) of the reference-plane plate (4) and in order to press, with the radial force, the clamping and positioning pins (21, 22) with their positioning surfaces (37, 38) against the reference surfaces (16, 17).

2. The clamping device as defined in claim 1, characterized in that the planar clamping surface (5) is a continuous surface interrupted solely by the clamping openings (8, 9, 10, 11).

3. The clamping device as defined in claim 1, characterized in that the planar base surface (7) is a throughgoing, coherent surface.

4. The clamping device as defined in claim 1, characterized in that the clamping and positioning pins (21, 22, 23, 24) have a size and a position such that in their relaxed state they project into the clamping openings (8, 9, 10, 11) and their positioning surfaces (37, 38) are remote from the reference surfaces (16, 17, 18, 19).

5. The clamping device as defined in claim 1, characterized in that the clamping and positioning pins (21, 22, 23, 24) are undersized relative to the clamping openings (8, 9, 10, 11).

6. The clamping device as defined in claim 1, characterized in that the clamping and positioning pins (21, 22, 23, 24) are resilient in the radial direction.

7. The clamping device as defined in claim 4, characterized in that the clamping and positioning pins are resilient in the radial direction and the maximum spring stroke of the clamping and positioning pins (21, 22, 23, 24) is greater than the distance of the positioning surfaces (37, 38) of the clamping and positioning pins (21, 22, 23, 24) from the reference surfaces (18, 19).

8. The clamping device as defined in claim 1, characterized in that the reference surfaces (16, 17, 18, 19) of the clamping openings (8, 9, 10,11) and the positioning surfaces (37, 38) of the clamping and positioning pins (21, 22, 23, 24) are each cylindrically curved.

9. The clamping device as defined in claim 1, characterized in that the clamping and positioning pins (21, 22, 23, 24) have a cylindrical basic shape and a clamping opening (31, 32).

10. The clamping device as defined in claim 1, characterized in that the clamping opening (31, 32) is wedge shaped.

11. The clamping device as defined in claim 1, characterized in that the clamping opening (31, 32) has frustoconical boundary surfaces.

12. The clamping device as defined in claim 1, characterized in that a total of four clamping openings (8, 9, 10, 11) and four clamping and positioning pins (21, 22, 23, 24) are provided.

13. The clamping device as defined in claim 1, characterized in that the tightening device (4) is associated with the reference-plane plate (4) and that the tightening device (40) pairwise forces apart mutually facing clamping and positioning pins (21, 22, 23, 24).

14. The clamping device as defined in claim 1, characterized in that the tightening device (237) is disposed in the reference-plane plate (204) and that the tightening device (237) forces the clamping pins radially away from a clamping center (287).

15. The clamping device as defined in claim 13, characterized in that the tightening device (37) comprises clamping plungers (41, 42, 43, 44) which are radially shiftably supported with respect to the clamping pins (8, 9, 10, 11).

16. The clamping device as defined in claim 15, characterized in that the clamping plungers (41, 42, 43, 44) are driven in synchronism.

17. The clamping device as defined in claim 15, characterized in that a respective resetting device (66, 67) is associated with each clamping plunger (41, 42, 43, 44).

18. The clamping device as defined in claim 15, characterized in that the clamping plungers (41, 42, 43, 44) are connected with a driving device (59) by means of a cam drive (65).

19. The clamping device as defined in claim 1, characterized in that the clamping plungers (141, 142, 143, 144) are connected with a driving device (186) by means of a hydraulic gearing (187).

20. The clamping device as defined in claim 1, characterized in that a pre-centering device (26, 28) is associated with each clamping pin (41, 42, 43, 44).

21. The clamping device as defined in claim 1, characterized in that a press-down device (71, 72) is associated at least with one of the clamping pins (41, 42, 43, 44).
